(19) United States
(12) Patent Application Publication
(10) Pub. No.: US 2006/0165271 A1
(43) Pub. Date: Jul. 27, 2006

(54) Method for reducing cupping artifacts in cone beam CT image data sets

(75) Inventors: Daniel Fischer, Erlangen (DE); Dieter Ritter, Furth (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/336,225

(22) Filed: Jan. 20, 2006

(30) Foreign Application Priority Data
Jan. 24, 2005 (DE) 10 2005 003 227.3

(51) Int. Cl. G06K 9/00

(52) U.S. Cl. 382/131

(57) ABSTRACT

In a method for reduction of cupping artifacts in cone beam CT image data sets, an image data set containing cupping artifacts is electronically processed with a harmonization procedure.

### BACKGROUND OF THE INVENTION

1. Field of the Invention

The present invention concerns a method for reducing cupping artifacts in cone beam CT image data sets.

2. Description of the Prior Art

In cone beam computed tomography (CT), a fan-shaped x-ray beam is not used, but rather a conical x-ray beam. The reconstruction is based on the technique known as filtered back projection, which is also applied in other CT modalities, for example fan ray CT. Filtered back projection involves a convolution or filter algorithm that significantly influences the image character, for example the spatial resolution and noise. In the back-projection itself, the filtered raw data of the individual 2-D projections are projected back corresponding to their angular position in the image matrix. Conventionally, low-contrast applications (representation of soft tissues) was only conditionally possible. Due to newly developed area detectors and powerful generators, 3-D reconstructions of soft tissues with sufficient image quality are now possible. The visualization of soft tissues requires a particularly small or hard windowing due to low contrast differences. This means that a relatively small grey value or CT value range is spread over the entire grey value range of the monitor image. In the most important representation, namely axial reconstruction, cupping artifacts frequently appear. These are thereby a lightening or darkening in the boundary region of a subject. A constant component that prevents the application of a small windowing is added to the actual image signal. The physical cause of these artifacts can be, for example, radiation hardening, inadequate water normalization, sub-optimal pre-filtering or sub-optimal truncation correction. The cupping artifacts are conventionally eliminated or at least reduced by appropriate correction of the cited causes. In many cases, however, a viable correction is not entirely possible due insufficient system hardware performance, inadequate subject information or inadequate algorithms, etc.

### SUMMARY OF THE INVENTION

An object of the present invention is to provide a method for reducing cupping artifacts in cone beam CT image data sets that can be implemented in a simple manner and without large hardware expenditure.

This object is achieved according to the invention by processing the image data set containing a cupping artifact with an automatically electronically implemented harmonization procedure. Harmonization is known for adaptation of the dynamic range in 2-D x-ray imaging and mammography for the purpose of optimally compensating the various tissue thicknesses (and thereby compensating global image brightenings) in an x-ray image in order to generate an equally-distributed image brightness for the diagnosis. The invention is based on the general idea of a symptomatic artifact correction, in contrast to conventional methods that focus, often a very elaborate manner, or the causes for cupping artifacts. It has been shown that artifacts of the type discussed herein can be eliminated or reduced by the use of a harmonization method that is known for other purposes, at least insofar as that the visualization of an image data set allows a reliable diagnosis. The harmonization is advantageously (because it is possible with relatively low calculation outlay) effected in 2D image data sets or a 3D reconstruction. It is also possible to implement the harmonization in the voxel data of a 3-D image data set. With regard to cupping artifacts, a completely corrected (thus artifact-free) 3D data set then exists from which arbitrary slices can be generated.

### DESCRIPTION OF THE DRAWINGS

FIG. 1 schematically illustrates an axial slice through the human pelvic region with cupping artifacts at the upper and lower subject boundary,

FIG. 2 shows the axial slice of FIG. 1, revised with a harmonization in accordance with the inventive method.

FIG. 3 is a diagram showing the intensity distribution of an image line in the region of the lower cupping artifact shown in FIG. 1.

FIG. 4 is a diagram showing the intensity distribution across an image line after application of the harmonization.

### DESCRIPTION OF THE PREFERRED EMBODIMENTS

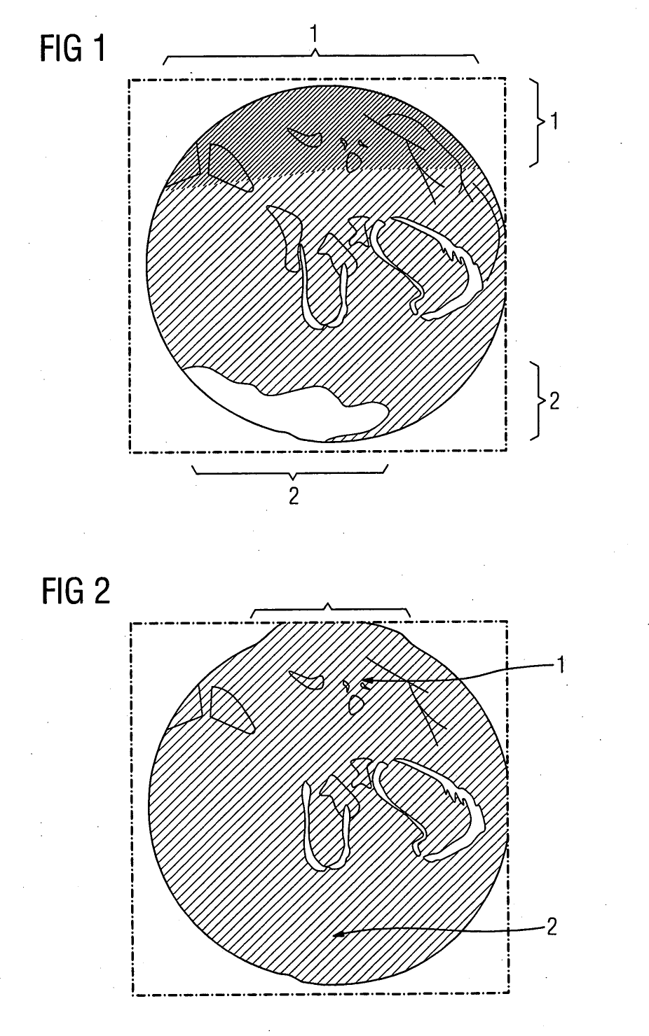

Two cupping artifacts, namely a darkening of the upper region 1 and a brightening of the lower subject region 2, are present the axial slice of a human pelvic region in FIG. 1. A small windowing to increase contrast is not practically possible in these regions, in particular in the region 2. However, a distinct contrast increase in the cited subject regions 1 and 2 is achieved by the application of a harmonization method (FIG. 2).

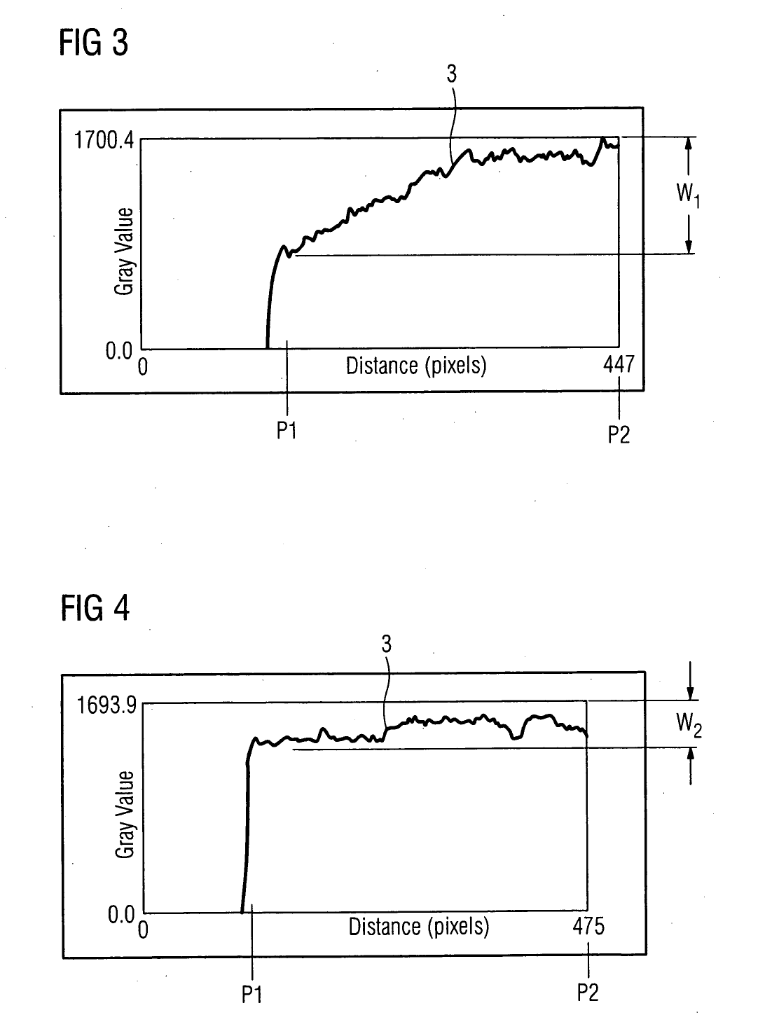

The cupping artifact of the subject region 2 is explained in FIG. 3 using an image line of an area detector. In the diagram, the removal (in pixels) is plotted on the abscissa and the grey value is plotted on the ordinate. It is clearly seen that a constant component is superimposed on the actual shortwave image signal 3. If it is now desired to spread the subject region or segment of the image line proceeding from the position P1 to the position P2 on the grey level scale of a monitor, only a relatively large grey level window W1 is available for this purpose. The shortwave signal portions 3 naturally exhibit only a slight contrast improvement, as is, for example, to be seen from FIG. 1. If the long-wave portion is now eliminated with a harmonization method, the window range W2 of the region of interest P1-P2 of the image row is significantly decreased. The shortwave image signal 3 now can be spread over the grey value scale of the monitor with a corresponding contrast increase.

The suitable, known harmonization described in, for example, K. Wiesent et al., “Enhanced 3-D-Reconstruction Algorithm for C-arm Systems Suitable for Interventional Procedures”, IEEE Trans. on Medical Imaging, Vol. 19, No. 5, May 2000 is explained briefly in the following:

The harmonization algorithm reduces the low frequency portion (the aforementioned constant component) while obtaining the detail contrast of the image. This allows a smaller grey value window and therefore a further contrast intensification. A region g of the low-pass-filtered signal is subtracted from the original input signal s. In order to reproduce the background brightness mapping, a term g·LP{s₃}(x_{ROI}, Y_{ROI}) is added. This is the average value of a region of interest (ROI), whereby x_{ROI} and Y_{ROI} are the coordinates of this range. A harmonized signal can be reproduced by the following formula:
s₄(x, y)=s₃(x, y)−g·LP{s₃}(x, y)+g·LP{s₃}(x_{ROI}, y_{ROI}).

The low-pass operation is implemented by a convolution or filtering of the original image data set with a quadratic (in terms of magnitude) convolution kernel, for example a 60×60 pixel matrix. Due to the large size of the convolution kernel, an expansion of the image signal is required across its image borders. This is achieved by a mirroring (reflection) of the signal at the image borders.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for reducing cupping artifacts in a cone beam computed tomography image data set, comprising the steps of:
automatically electronically processing an image data set, comprising cone beam computed tomography image data subject to cupping artifacts, with a harmonization procedure to reduce said cupping artifacts.

2. A method as claimed in claim 1 comprising implementing said harmonization procedure as a 2D image data set of a 3D reconstruction.

3. A method as claimed in claim 1 wherein said image data set is a 3D image data set, and implementing said harmonization procedure on voxel data of said 3D image data set.
